(19) United States
(12) Patent Application Publication
(10) Pub. No.: US 2004/0112958 A1
(43) Pub. Date: Jun. 17, 2004

(54) Coupon scanner organizer device

(76) Inventor: James T. Rosica, Warrington, PA (US)

Correspondence Address: Kenneth P. Glynn, Esq., Glynn & Associates, P.C., 24 Mine Street, Flemington, NJ, 08822, US

(21) Appl. No.: 10/319,230

(22) Filed: Dec. 13, 2002

(51) Int. Cl. G06K 15/00

(52) U.S. Cl. 235/383

(57) ABSTRACT

Coupon scanner organizer device is a hand holdable, portable coupon bar code reading unit having a bar code optical sensor, signal conversion electronics, a microprocessor, a memory, a power source and coupon transmission mechanism to transmit stored coupon information to a bar code reading cash register. It has software to organize and store a plurality of coupon readings for a plurality of diverse coupons. The actual scanning components and conversion electronics is a matter of design choice. The present invention device may include a connection mechanism for direct connection to a cash register e.g. wireless or wire connectable. This invention may be a conventional wire and port arrangement, e.g. at least one plug and at least one plug receptacle. In some embodiments, the connection mechanism is adapted to nest in a nesting device connected to a cash register. In other words, at each check out, a convenient nest or cradle for the device with plug or pin connection arrangements could be made possible to the user (consumer). The device would be placed in the stand and download could be automatic. The present invention also includes a coupon scanner organizer system having at least one device and at least one bar code reading cash register having sufficient hardware and software to receive a plurality of coupon readings for a plurality of diverse coupons from the device. The present invention also includes a methodology using the above technology.

### BACKGROUND OF THE INVENTION

1. Field of the Invention

The present invention is directed to a coupon scanner organizer device that is hand held and may be used to scan in newspaper coupon, monitor coupons, etc. out the user's connivance, to eliminate clipping, storing, etc, and is then used to download the scanned coupon information at the store register to obtain the represented coupon benefits. The present invention also includes the system with the cash register, as well as the methodology employed there with.

2. Information Disclosure Statement

The following patents illustrate prior art devices relating to coupon scanning:

U.S. Pat. No. 4,471,218 describes a self-contained, portable data entry terminal positioned within a cordless, wand-type enclosure. Positioned within the enclosure is a bar code optical sensor/emitter, signal conditioning electronics, a micro-processor, a memory, and a rechargable battery. The bar code optical reader functions as both a sensor and an emitter to permit the readout of data stored in the memory.

U.S. Pat. No. 5,047,614 discloses a method and means to aid shopping which includes the use by a consumer of a portable bar code scanner having an electronic memory. The consumer enters desired items into the memory by scanning bar codes on, for example, containers, coupons, advertisements, and pamphlets furnished by a store. The memory is then read by a store terminal which may compile a printed shopping list and/or may transmit the order to a warehouse environment for manual and/or automatic order picking. The memory may be read by the store terminal over a telephone line via a modem.

U.S. Pat. No. 5,595,264 describes a system and method of automated shopping, including a portable bar code scanner for scanning bar code indicia information on items selected to be purchased, securing the scanner in a holder for limited access, and releasing the portable bar code scanner upon receiving an authorized payment card. A plurality of items for purchase are displayed in a store such that a customer can select an item to be purchased from the store display. The customer scans the bar code indicia on the selected item from the store display. The payment card is debited for the purchase price of the selected item and the returned to the customer.

U.S. Pat. No. 5,918,211 describes a system and method for influencing and potentially altering a consumer's purchase decisions at the point-of-purchase in a retail store using a portable bar code scanner that is in constant wireless communication with the store and a retailer/manufacturer's computer/controller. The consumer uses the portable bar code scanner to scan products in the store, and if a scanned product is currently under a promotion, the controller alerts the consumer's portable bar code scanner as to the promotion, so that the consumer can to take advantage of the promotion. In another embodiment, the consumer will be identified before beginning shopping by their frequent shopper card, so that the computer/controller, in communication with the portable bar code scanner, can utilize the consumer's past purchase discounts. A video surveillance camera within the portable bar code scanner also allows the retailer to monitor each portable bar code scanner's use throughout the retail establishment for security purposes.

Notwithstanding the prior art, the present invention is neither taught nor rendered obvious thereby.

### SUMMARY OF THE INVENTION

The present invention, in some essential embodiments, is a coupon scanner organizer device. The device is a hand holdable, portable coupon bar code reading unit having a bar code optical sensor, signal conversion electronics, a microprocessor, a memory, a power source and coupon transmission means to transmit stored coupon information to a bar code reading cash register. It also has sufficient software to organize and store a plurality of coupon readings for a plurality of diverse coupons. The actual scanning components and conversion electronics is a matter of design choice. Scanners have been widely used for a number of years, and the technology of internal components is well with in the purview of the artisan.

The present invention coupon scanner organizer device may preferably include a connection means for direct connection to a cash register. This invention may be a conventional wire and port arrangement, e.g. at least one plug and at least one plug receptacle. In some embodiments, the connection means is adapted to nest in a nesting device connected to a cash register. In other words at each check out, a convenient nest or cradle for the device with plug or pin connection arrangements could be made possible to the user (consumer). The device would be placed in the stand and download could be automatic.

Some optional features of the device may include printer features, e.g. to print out lists of stored coupon data and/or to print out actual coupons, e.g. per use at stores and other locations where cash register may read coupons, but cannot be looked up to or receive input from the device. An attentive to or in addition with any confirmation of the above, the device may utilize wireless means to input coupon data to a cash register.

Other options include sufficient software to receive user store discount card information and to provide said information to a store cash register.

Thus, the coupon scanner organizer device of the present invention may be selected from the group consisting of a stand-alone unit, a wireless telephone, a personal organizer, a personal digital assistant, a hand held computer, a wireless hand held computer, or any other similar device capable of scanning and processing.

The present invention also includes coupon scanner organizer system having at least one device that is a hand holdable, portable coupon bar code reading unit having a bar code optical sensor, signal conversion electronics, a microprocessor, a memory, a power source and coupon transmission means to transmit stored coupon information to a bar code reading cash register, and having sufficient software to store a plurality of coupon readings for a plurality of diverse coupons; and at least one bar code reading cash register having sufficient hardware and software to receive a plurality of coupon readings for a plurality of diverse coupons from the device, and to credit a user in possession of the device for coupon readings that have not expired and relate to purchased goods or services. In other words, a system utilizing the present invention devise is included overview and all of the feathers described above may be included.

The present invention also includes a methodology to enable a consumer to procure printed merchandise and services coupons from printed matter and presenting them to offering entities without the need to clip or physically carry the printed coupons. The styles of this methodology includes:

a.) providing a consumer with a coupon scanner organizer device that is a hand holdable, portable coupon bar code reading unit having a bar code optical sensor, signal conversion electronics, a microprocessor, a memory, a power source and coupon transmission means to transmit stored coupon information to a bar code reading cash register, and having sufficient software to store a plurality of coupon readings for a plurality of diverse coupons;

b.) providing a coupon accepting entity with at least one bar code reading cash register having sufficient hardware and software to receive a plurality of coupon readings for a plurality of diverse coupons from the device, and to credit a user in possession of the device for coupon readings that have not expired and relate to purchased goods or services;

c.) scanning at least one printed coupon into the coupon scanner organizer device. (Here the user will typically scan at home or work or other place and time of convenience, and later carry the device to the coupon accepting entity, i.e. shop or store or other commercial location for downloading.);

d.) taking the coupon scanner organizer device to a bar code reading cash register and feeding the scanned printed coupon data to said cash register; and,

e.) where appropriate, granting coupon benefits to the user of the device in accordance with the data.

All of the above features described for the present invention device may be utilized in the methodology. It is envisioned that many devices, cash registers and commercial entities will utilize these devices, systems and methodologies.

### BRIEF DESCRIPTION OF THE DRAWINGS

The present invention should be more fully understood when the specification herein is taken in conjunction with the drawings appended hereto wherein:

FIG. 1 illustrates a schematic representation of present innovation device and its functions;

FIG. 2 shows various options for transmitting coupon information to a cash register; and,

FIG. 3 shows a schematic diagram of a present invention system and methodology utilizing plural users and plural cash registers.

### DETAILED DESCRIPTION OF THE PRESENT INVENTION

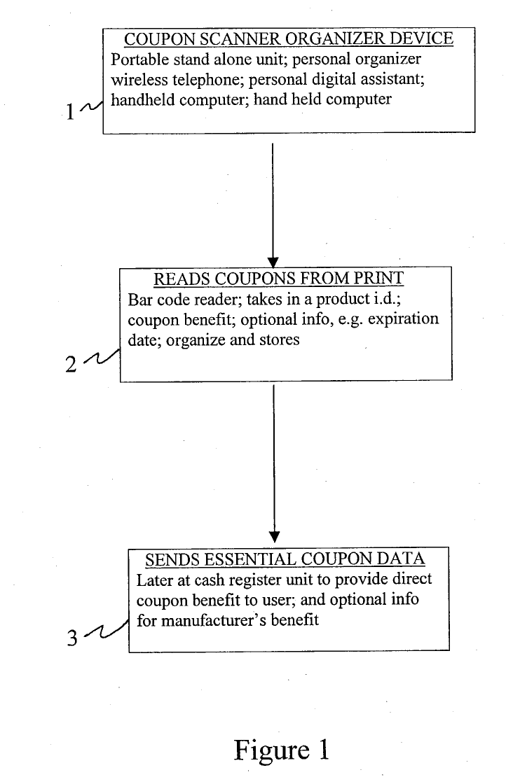

FIG. 1 shows the overall process of the present invention device, system and methodology of the present invention. Specifically, in FIG. 1, Frame 1 shows a coupon scanner organizer device of the present invention, indicating various alternative types of units. A stand alone unit is a unit that performs only the essential functions of a present invention device. This could be a wireless device or wire connectable device. Alternatively, the essential functions of the present invention could be incorporated into devices having other functions, among these might be a cellular telephone, personal digital assistant, personal organizer, hand held computer, or wireless hand held computer. The device reads coupons from print, frame 2. The device will read essential coupon information from a printed newspaper, magazine, mailer or other source and organize and store critical data such as the coupon benefit and the expiration date, as well as any limitations contained with in the barcode. Next, a user will go to a commercial entity such as a grocery store, department store, tire store, or the like where the device sends essential coupon data to a cash register to benefit the user, frame 3.

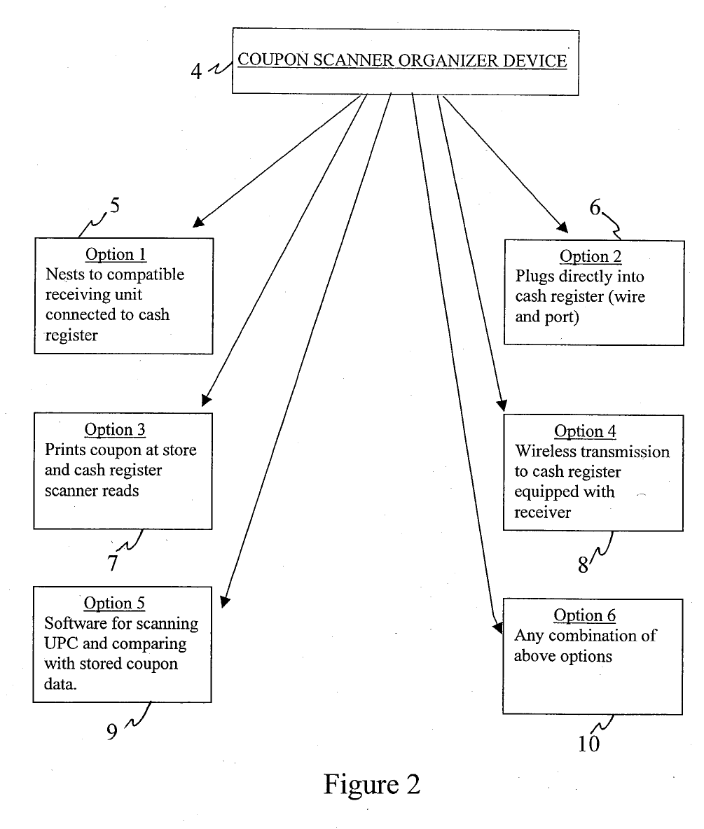

FIG. 2 illustrate schematically various functional Options available to the scanner device 4. Frame 5 shows Option 1 wherein the device nests into a receiving unit electronically connected to the cash register. Alternatively, Frame 6 shows Option 2 wherein the device plugs directly into a cash register for downloading. This could be a simple wire and port mechanism, or other similar arrangement. Frame 7 shows a third option (Option 3) wherein the device has print capabilities and the user prints the coupon at the store and then the cash register scanner reads the coupon. This would be especially useful with existing cash registers, which have not been adapted to receive electronic input from the device.

Option 4 (Frame 8) relates to wireless transmission to cash registers equipped with receivers. This would be done by direct radio transmission from the device to the cash register or via. some system involving both wireless and wire transmission such as wireless to a satellite and back to an internet server or directly to the hand held device, or both.

Option 5 shown in Frame 9 involves the use of additional software to enable a user to scan actual products in the store by scanning the universal price code on the product with stored coupon data to then signal the user as to whether or not there is a coupon/product match.

Option 5 shown in frame 14 shows that any combination of the foregoing options may be incorporated in the device.

The functional aspect of the bar code reader components of the present invention device may be standard components, typically involving a light emitting element (LED), for transmitting light to the coupon bar code, a photodiode for reception of the reflected light and absence thereof from the LED, signal conditioning electronics, typically including an amplifier and an analog-to-digital converter, a microprocessor for the receiving, organization, storage and ultimate transmission. Software for bar code read digital data organization, storage, retrieval and transfer is well known, and the interpretation (meaning) of bar code symbols is standardized. Likewise, the ability to transfer digital data from one device to another is also well known, for wireless, direct feed internet transmission. A viewer, e.g. an LCD view screen, could be included to display a coupon list, e.g. by product alphabetically, or by expiration date, or otherwise.

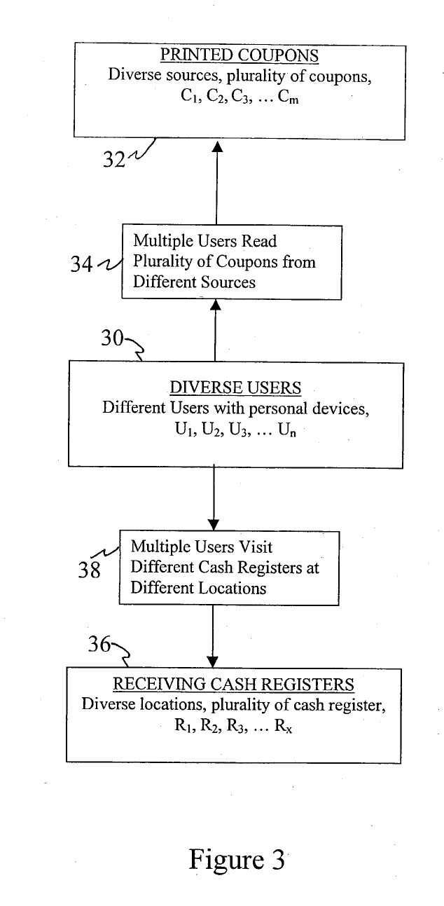

FIG. 3 illustrates schematically a broad view representation of a preferred present invention system and methodology. Frame 30 shows a plurality of users, each with their own personal scanner organizer device as described above and as shown in FIG. 2. Frame 32 illustrates the reality if many different types of coupons from many devices. These could be from newspaper, mailers, hand outs, store counter dispenser, magazines, e-mails, or any other format, and could be for any form of goods, services or combination thereof imaginable, from lawyer Will discounts, to pedicure, to house additions, to the more typical grocery store, deportment store and home improvements store coupons. Hence, they are an infinitely expandable collection of coupons C₁, C₂, C₃ through Cₘ where n is an extremely large indeterminate number.

The users U₁, U₂, U₃ . . . Uₙ, where m represents all of the users having device of the present invention above, scan the printers coupons in any amount, from any device in any order desired (up to the capacity of the devices), frame 34. The devices read (scan) the coupons, create digital coupon data, organize the data by coupon and store it for subsequent use. The typical data would be product i.d., that is, brand, product, size, as well as benefit provided, e.g. $0.05 off; or buy one, get second 50% off; or free ladder with pool purchase, etc. as well as expiration dates. (The devices may or may not procure information such as expiration dates, manufacturer's information for store redemption back to the offeree, etc. These features depend upon the design of the device and/or the availability of such information from the bar code reading. The devices, cash registers and bar codes would all have to be compatible in this respect to optimize these features of the present invention. For example, the bar codes could have more bars or encryption's to include this information and the devices and cash registers would have read/convert/store/transmit/credit/reject capabilities in the respective software packages.)

These users then take their devices to different cash registers at different locations, frame 38. The receiving cash registers, frame 36, R₁, R₂, R₃ . . . Rₓ where x is the number of cash registers available to the users, will receive input form the devices, as the users purchase goods and/or for services or otherwise redeem the coupon. If there is a match (valid) use, the cash register will okay or credit the user with the coupon benefit. This enables users to eliminate coupon clippings, avoid borrowing scanners, using central coupon printers at stores, or otherwise become involved in unnecessary, time consuming steps.

Obviously, numerous modifications and variations of the present invention are possible in light of the above teachings. For example, the devices could include software that would cause the earliest to expire coupons to be used ahead of otherwise identical coupons with later expiration dates. Additionally, the device could be used to scan coupons at the store or to scan UPC labels on products at the store to see if there is a match with stored coupons before taking the product for purchase. Also, the device could provide histories, benefit values and other desired information regarding currently stored and previously stored coupons. Another feature could be signal or flashing list or other indicator to a user that applicable stored coupons are about to expire or have expired. Expired coupons could be automatically deleted or be deleted at the option of the user. Further, while the device is described as “hand holdable”, this does not mean that the user must hold the device. A wrist, arm, hip or clothing attached device or necklace device would also be able to be hand held and within the purview of the present invention. It is therefore understood that within the scope of the appended claims, the invention may be practiced otherwise than as specifically described herein.

What is claimed is:

1. A coupon scanner organizer device, which comprises:
a hand holdable, portable coupon bar code reading unit having a bar code optical sensor, signal conversion electronics, a microprocessor, a memory, a power source and coupon transmission means to transmit stored coupon information to a bar code reading cash register, and having sufficient software to store a plurality of coupon readings for a plurality of diverse coupons.

2. The coupon scanner organizer device of claim 1 wherein said software further includes sufficient software to read universal price code bars on products and to compare with stored coupon data, and to signal whether or not there is a match between a scanned product and stored coupon data.

3. The coupon scanner organizer device of claim 1 wherein said unit includes connection means for connection to a cash register that is selected from the group consisting of wireless connection and wire connection having one of at least one plug and at least one plug receptacle.

4. The coupon scanner organizer device of claim 2 wherein said connection means is adapted to nest in a nesting device connected to a cash register.

5. The coupon scanner organizer of claim 1 wherein there is also sufficient software to receive user store discount card information and to provide said information to a store cash register.

6. The coupon scanner organizer device of claim 1 wherein said portable coupon bar code reading unit is selected from the group consisting of a stand-alone unit, a wireless telephone, a personal organizer, a personal digital assistant and a hand held computer.

7. A coupon scanner organizer system, which includes:
a.) at least one device that is a hand holdable, portable coupon bar code reading unit having a bar code optical sensor, signal conversion electronics, a microprocessor, a memory, a power source and coupon transmission means to transmit stored coupon information to a bar code reading cash register, and having sufficient software to store a plurality of coupon readings for a plurality of diverse coupons; and,
b.) at least one bar code reading cash register having sufficient hardware and software to receive a plurality of coupon readings for a plurality of diverse coupons from said unit, and to credit a user in possession of said at least one device for coupon readings that have not expired and relate to purchased goods or services.

8. The coupon scanner organizer system of claim 7 wherein said portable coupon bar code reading unit includes a connection means for direct connection to a cash register.

9. The coupon scanner organizer system of claim 8 wherein said connection means is selected from the group consisting of wireless connection and wire connection having one of at least one plug and at least one plug receptacle.

10. The coupon scanner organizer system of claim 8 wherein said cash register includes a unit connection means nesting device connected to it, and said nesting device is adapted to receive and nest said connection means of said unit.

11. The coupon scanner organizer system of claim 7 wherein there is also sufficient software to receive user store discount card information and to provide said information to a store cash register.

12. The coupon scanner organizer system of claim 7 wherein said portable coupon bar code reading unit is selected from the group consisting of a stand-alone unit, a wireless telephone, a personal organizer, a personal digital assistant and a hand held computer.

13. A methodology to enable a consumer to procure printed merchandise and services coupons from printed matter and presenting them to offering entities without the need to clip or physically carry the printed coupons, which comprises:
a.) providing a consumer with a coupon scanner organizer device that is a hand holdable, portable coupon bar code reading unit having a bar code optical sensor, signal conversion electronics, a microprocessor, a memory, a power source and coupon transmission means to transmit stored coupon information to a bar code reading cash register, and having sufficient software to store a plurality of coupon readings for a plurality of diverse coupons;
b.) providing a coupon accepting entity with at least one bar code reading cash register having sufficient hardware and software to receive a plurality of coupon readings for a plurality of diverse coupons from said unit, and to credit a user in possession of said at least one device for coupon readings that have not expired and relate to purchased goods or services.
c.) scanning at least one printed coupon into said coupon scanner organizer device;
d.) taking said coupon scanner organizer device to said at least one bar code reading cash register and feeding said at least one scanned printed coupon data to said cash register; and,
e.) where appropriate, granting coupon benefits to said user of said cash register in accordance with said data.

14. The methodology of claim 13 wherein said portable coupon bar code reading unit includes a connection means for direct connection to a cash register.

15. The methodology of claim 14 wherein said connection means is selected from the group consisting of wireless connection and wire connection having one of at least one plug and at least one plug receptacle.

16. The methodology of claim 14 wherein said cash register includes a unit connection means nesting device connected to it, and said nesting device is adapted to receive and nest said connection means of said unit.

17. The methodology of claim 13 wherein there is also sufficient software to receive user store discount card information and to provide said information to a store cash register.

18. The methodology of claim 13 wherein said portable coupon bar code reading unit is selected from the group consisting of a stand-alone unit, a wireless telephone, a personal organizer, a personal digital assistant and a hand held computer.

19. The methodology of claim 13 wherein a plurality of barcode reading cash registers are networked to one another.

20. The methodology of claim 13 wherein said coupon scanner organizer device includes a coupon printout feature and wherein at least one non-barcode reading cash register is provided.
